(19) United States
(12) Patent Application Publication
(10) Pub. No.: US 2021/0070017 A1
(43) Pub. Date: Mar. 11, 2021

(54) NANO PARTICLE SOLAR CONTROL FILM

(71) Applicant: Racing Optics, Inc., Las Vegas, NV (US)

(72) Inventors: Bart E. Wilson, Las Vegas, NV (US); Stephen S. Wilson, Las Vegas, NV (US)

(21) Appl. No.: 17/014,923

(22) Filed: Sep. 8, 2020

Related U.S. Application Data
(60) Provisional application No. 62/897,615, filed on Sep. 9, 2019.

(51) Int. Cl. B32B 17/06; G02F 1/01; B60J 1/00

(52) U.S. Cl. CPC B32B 17/064; G02F 1/0102; B60J 1/001; B32B 2605/00; G02F 2202/022; G02F 2202/36; G02F 2202/28

(57) ABSTRACT

A solar control system for a vehicle window includes a substrate made of biaxially-oriented polyethelene terephthalate, a thermochromic film formed on the substrate or on an intervening dielectric layer that is formed on the substrate, and a protective layer. The protective layer may be made of biaxially-oriented polyethelene terephthalate and may be laminated on the thermochromic film or on a thermochromic core comprising one or more thermochromic film(s) and/or dielectric layer(s). The thermochromic film may include vanadium dioxide nanocrystals. The solar control system may be applied to a vehicle window such as a windshield of an automobile.

### CROSS-REFERENCE TO RELATED APPLICATIONS

This application relates to and claims the benefit of U.S. Provisional Application No. 62/897,615, filed Sep. 9, 2019 and entitled “NANO PARTICLE SOLAR CONTROL FILM,” the entire contents of which is expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to solar control systems for vehicles and, more particularly, to a solar control film that may be applied to a vehicle window such as a windshield of an automobile.

### 2. Related Art

In order to reduce the energy consumption of air conditioning systems, efforts have been made to limit the solar radiation entering a vehicle. For example, U.S. Pat. No. 8,361,260, the entire contents of which is hereby incorporated by reference, describes the use of a silver layer that may be applied to a painted metal exterior of an automobile in order to reflect near and mid infrared while being transparent to visible light (to allow the paint to be seen). However, during the cold part of the year, such systems may have the adverse effect of increasing the energy consumption of vehicle heating systems, as the sun's rays are prevented from desirably heating the vehicle. Moreover, silver is an expensive material.

### BRIEF SUMMARY

The present disclosure contemplates various systems and methods for overcoming the above drawbacks accompanying the related art. One embodiment of the present disclosure is a solar control system for a vehicle window. The solar control system may include a substrate made of biaxially-oriented polyethelene terephthalate and a thermochromic film formed on the substrate, the thermochromic film including vanadium dioxide nanocrystals. The solar control system may further include a protective layer laminated on the thermochromic film, the protective layer made of biaxially-oriented polyethelene terephthalate.

The solar control system may include an ultraviolet light absorbing adhesive between the protective layer and the thermochromic film.

The solar control system may include one or more sacrificial layers laminated on the protective layer, the one or more sacrificial layers made of biaxially-oriented polyethelene terephthalate. The solar control system may include an ultraviolet light absorbing adhesive between the one or more sacrificial layers and the protective layer. Each of the one or more sacrificial layers may include a tab for peeling off the sacrificial layer.

The solar control system may include a pressure sensitive adhesive disposed on an opposite side of the substrate as the thermochromic film.

Another embodiment of the present disclosure is a solar control system for a vehicle window. The solar control system may include a substrate made of biaxially-oriented polyethelene terephthalate and a thermochromic core disposed on the substrate, the thermochromic core comprising a first dielectric layer formed on the substrate and a first thermochromic film formed on the first dielectric layer, the first thermochromic film including vanadium dioxide nanocrystals. The solar control system may further include a protective layer laminated on the thermochromic core, the protective layer made of biaxially-oriented polyethelene terephthalate.

The solar control system may include an ultraviolet light absorbing adhesive between the protective layer and the thermochromic core.

The thermochromic core may further include a second dielectric layer formed on the first thermochromic film. The thermochromic core may further include a second thermochromic film formed on the second dielectric layer, the second thermochromic film including vanadium dioxide nanocrystals. The thermochromic core may further include a third dielectric layer formed on the second thermochromic film.

The solar control system may include one or more sacrificial layers laminated on the protective layer, the one or more sacrificial layers made of biaxially-oriented polyethelene terephthalate. The solar control system may include an ultraviolet light absorbing adhesive between the one or more sacrificial layers and the protective layer. Each of the one or more sacrificial layers may include a tab for peeling off the sacrificial layer.

The solar control system may include a pressure sensitive adhesive disposed on an opposite side of the substrate as the thermochromic core.

Another embodiment of the present disclosure is a solar control method for a vehicle. The solar control method may include providing a substrate made of biaxially-oriented polyethelene terephthalate, forming a first dielectric layer on the substrate, and forming a first thermochromic film on the first dielectric layer, the first thermochromic film including vanadium dioxide nanocrystals. The solar control method may further include laminating a protective layer on a thermochromic core comprising the first dielectric layer and the first thermochromic film, the protective layer made of biaxially-oriented polyethelene terephthalate.

The solar control method may include rolling the substrate into a roll between forming the first dielectric layer and forming the first thermochromic film.

The solar control method may include disposing a pressure sensitive adhesive on an opposite side of the substrate as the thermochromic core. The solar control method may include wetting down a surface of a vehicle window, laying the substrate on the surface of the vehicle window with the side having the pressure sensitive adhesive against the surface of the vehicle window, and pressing the substrate against the surface of the vehicle window. The solar control method may include laminating one or more sacrificial layers on the protective layer, the one or more sacrificial layers made of biaxially-oriented polyethelene terephthalate. The solar control method may include peeling off an outermost sacrificial layer of the one or more sacrificial layers after pressing the substrate against the surface of the vehicle window.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a solar control system according to an embodiment of the present disclosure; and

FIG. 2 is an example operational flow for manufacturing, installing, and using the solar control system;

FIG. 3 is an example operational flow of step 210 of FIG. 2; and

FIG. 4 is an example operational flow of step 240 of FIG. 2.

### DETAILED DESCRIPTION

The present disclosure encompasses various solar control systems and methods. The detailed description set forth below in connection with the appended drawings is intended as a description of several currently contemplated embodiments. It is not intended to represent the only form in which the disclosed subject matter may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

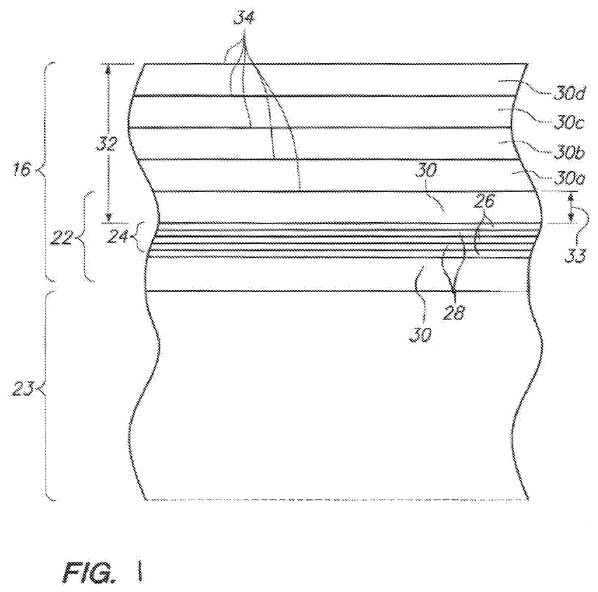

FIG. 1 is a cross-sectional view of a solar control system 16 according to an embodiment of the present disclosure. As shown, the solar control system 16 may be applied to an exterior surface of a window 23 of a vehicle. The window 23 may be an automobile windshield, for example. The solar control system 16 may include a thermochromic core 24 sandwiched between layers 30 of biaxially-oriented polyethelene terephthalate (BoPET), the thermochromic core 24 comprising one or more thermochromic films 28. The thermochromic film(s) 28 may include vanadium dioxide nanocrystals, which may be appropriately synthesized and/or doped to achieve a desired transition temperature. For example, the thermochromic film(s) 28 may be made to have a transition temperature of around 25° C. or another selected transition temperature between 25° C. and 68° C. To this end, the thermochromic film(s) 28 may be made according to the processes described in U.S. Pat. No. 9,975,804, the entire contents of which is hereby incorporated by reference. Owing to the presence of the one or more thermochromic films 28, the solar control system 16 may transition between reflecting near and mid infrared in warm weather conditions and transmitting near and mid infrared in cold weather conditions, all while transmitting a majority of the incident visible light (e.g. 60%-80%). In this way, a comfortable interior temperature of the vehicle may be maintained year-round, and the energy consumption of both air conditioning and heating systems may be reduced.

In the example solar control system 16 shown in FIG. 1, the thermochromic core 24 includes two thermochromic films 28 disposed in alternating fashion between three dielectric layers 26. The thickness of each thermochromic film 28 and dielectric layer 26 may be on the order of nanometers, with the particular thicknesses and number of stacked layers being selected to tune the amount of infrared radiation reflected and/or the amount of visible light transmitted by the thermochromic core 24. It may be preferable for the outermost layers of the thermochromic core 24 to be dielectric layers 26 as shown in order to protect the thermochromic film(s) 28 during manufacture. It is also contemplated, however, that the thermochromic core 24 may include only a single thermochromic film 28 and no dielectric layers 26, in which case the thermochromic film 28 may be formed directly on one of the BoPET layers 30.

BoPET is the preferred material for the layers 30 that sandwich the thermochromic core 24 since it is dimensionally stable (i.e., not elastic), has high transmission in the visible and near and mid infrared ranges (e.g. greater than 50%, preferably about 90% or more), low scatter, and low cost, though the use of other materials with some or all of these qualities is also contemplated. The dimensional stability of the BoPET layers 30 provides support for the thermochromic film(s) 28. Otherwise, the thermochromic film(s) 28 may crack or become damaged upon stretching of the layers 30. The BoPET layers 30 may be approximately two thousandths of an inch thick.

In addition to the BoPET layers 30 sandwiching the thermochromic core 24, the solar control system 16 shown in FIG. 1 further includes a series of sacrificial layers 30a, 30b, 30c, 30d. The sacrificial layers 30a, 30b, 30c, 30d may have a high transmission value with respect to the visible range and the near and mid infrared ranges of solar radiation and may likewise be made of BoPET and may be approximately two thousandths of an inch thick. The topmost sacrificial layer 30d may be removed or peeled away when it has been unacceptably degraded due to environmental elements (e.g., chips, oxidation, etc.) thereby exposing a fresh new topmost layer 30c and so on. Additionally, the sacrificial layers 30a, 30b, 30c, 30d may mitigate oxidation of the thermochromic film(s) 28. In this way, vanadium dioxide (VO₂) may be prevented from transforming into vanadium pentoxide (V₂O₅), which may deteriorate the thermochromic properties of the thermochromic film(s) 28. Although oxygen may be diffused through the sacrificial layers 30a, 30b, 30c, 30d, such diffusion of oxygen through the sacrificial layers may be slowed down by increasing the thickness or number of the sacrificial layers 30a, 30b, 30c, 30d, bringing the rate of oxygen diffusion to an acceptable level.

During use, the exterior side 34 of the outermost sacrificial layer 30d may be exposed to environmental elements such as rain (containing chemicals), rocks, dirt, ultraviolet light, etc. As such, the exterior side 34 of the outermost sacrificial layer 30d may experience physical degradation (e.g., chips, oxidation, etc.). It may be difficult to see through the window 23 and solar control system 16 due to the degradation of the outermost sacrificial layer 30d over time. Beneficially, as described above, each of the sacrificial layers 30a-d may be removed (e.g., peeled away) from each other and also from the base layer 22 including the thermochromic core 24 and sandwiching BoPET layers 30. The next outermost layer 30a-d then behaves as a sacrificial layer which is removed when it has been unacceptably degraded by the environmental elements. To this end, the layer 30d may be peelably adhered to layer 30c, layer 30c may be peelably adhered to layer 30b, layer 30b may be peelably adhered to layer 30a, and layer 30a may be peelably adhered to the base layer 22. A tab or other means of removing each sacrificial layer 30a-d may be provided such that each sacrificial layer 30a-d may be peeled off of the adjacent sacrificial layer 30a-d when it becomes unacceptably degraded. Upon further use, the new outermost layer 30a-d may experience physical degradation and the process may be repeated. As the sacrificial layers 30a-d are peeled away, the rate of oxidation of the thermochromic layer(s) 28 increases. As such, the number of sacrificial layers 30a-d may be increased or decreased based on the required useful life of the solar control system 16. To extend the useful life of the solar control system 16, additional layers 30a-d may be stacked upon each other to increase the distance 32. Conversely, to decrease the useful life of the solar control system 16, fewer layers 30a-d may be stacked upon each other to decrease the distance 32. When the thermochromic film(s) 28 are unacceptably oxidized, the entire solar control system 16 may be removed from the window 23 and a new solar control system 16 may be mounted to the window 23.

Each of the sacrificial layers 30a-d, as well as the BoPET layer 30 laminated on the thermochromic core 24, may define an exterior side 34. An ultraviolet light absorbing adhesive may be used to adhere the exterior side 34 of the BoPET layer 30 to a first sacrificial layer 30a and to adhere the exterior side 34 of each sacrificial layer 30a-d to the next sacrificial layer 30a-d. An ultraviolet light absorbing hard coat may be coated onto the exterior side 34 of the outermost sacrificial layer 30d. The ultraviolet light absorbing adhesive and/or ultraviolet light absorbing hard coat may slow the damaging effects of ultraviolet light on the BoPET layer 30 and sacrificial layers 30a-d. An ultraviolet light absorbing adhesive may also be used for laminating the BoPET layer 30 on the thermochromic core 24, thus further slow any damaging effects of ultraviolet light exposure. Such adhesives may continuously cover most, if not all, of the BoPET layers 30, 30a-d and thermochromic core 24.

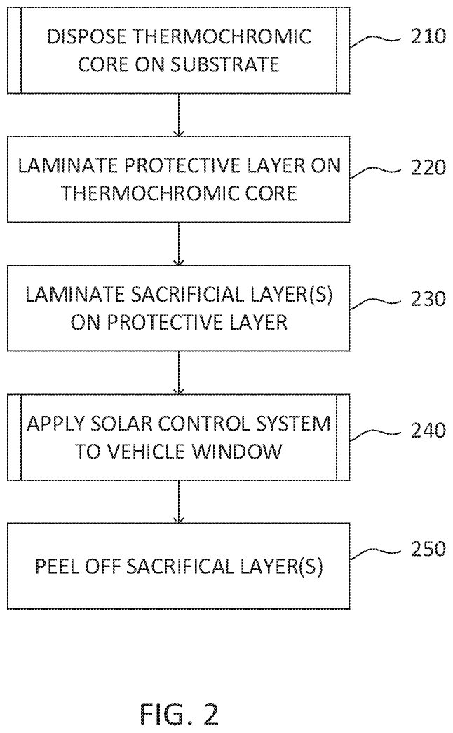

FIG. 2 is an example operational flow for manufacturing, installing, and using the solar control system 16. The operational flow of FIG. 2 may begin with a step 210 of disposing a thermochromic core 24 on a substrate. The substrate may be the lower BoPET layer 30 shown in FIG. 1 that will eventually be applied to the exterior of the window 23. As noted above, the thermochromic core 24 may include only a single thermochromic film 28 and no dielectric layers 26. In such case, disposing the thermochromic core 24 on the substrate (step 210) may involve simply forming the single thermochromic film 28 directly on the substrate. For example, a transparent hybrid polymer-nanorod dispersion or liquor as described in U.S. Pat. No. 9,975,804 may be produced and applied to the substrate by a coating method as described therein (see, e.g. col. 8, lines 47-60).

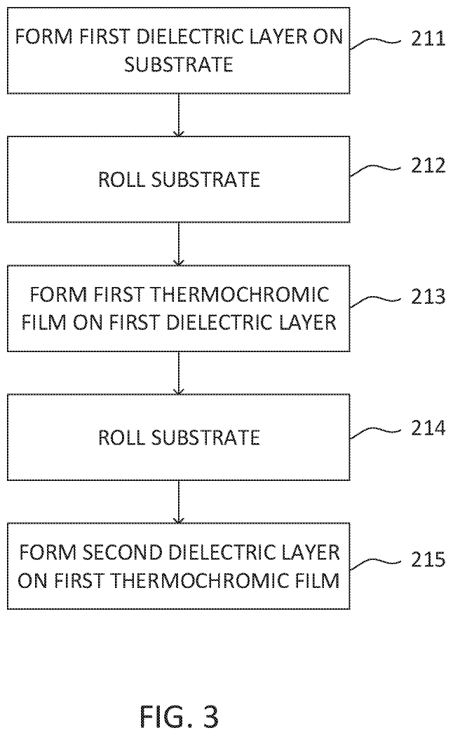

FIG. 3 is an example subprocess of step 210 for a case where the thermochromic core 24 includes one or more dielectric layers 26 and/or additional thermochromic films 28. The operational flow of FIG. 3 may begin with a step 211 of forming a first dielectric layer 26 on the substrate. Again, the substrate may be the lower BoPET layer 30 shown in FIG. 1 that will eventually be applied to the exterior of the window 23. A stack of one or more dielectric layers 26 and one or more thermochromic film 28 may be alternately formed on the substrate by a coating method such as roll coating. For example, the BoPET layer 30 serving as the substrate may be provided as a roll that is unrolled to form the first dielectric layer 26 on one side thereof in a step 211. As the first dielectric layer 26 is coated on one side of the substrate, the substrate may be rerolled in a step 212. The substrate may then be unrolled such that a first thermochromic film 28 may then be formed on top of the first dielectric layer 26 in a step 213. For example, a transparent hybrid polymer-nanorod dispersion or liquor as described in U.S. Pat. No. 9,975,804 may be produced and applied to the first thermochromic film 28 by a coating method as described therein (see, e.g. col. 8, lines 47-60). The substrate may then be rolled back up in a step 214 and unrolled to form a second dielectric layer 26 on the first thermochromic film 28 in a step 215 and further rolled and unrolled a number of times until the desired number of thermochromic films 28 and dielectric layers 26 are attained. As noted above, it may be preferable for the outermost layers of the thermochromic core 24 to be dielectric layers 26 as shown in FIG. 1 in order to protect the thermochromic film(s) 28 during the remainder of the manufacturing process.

Referring back to FIG. 2, the operational flow may continue with a step 220 of laminating a protective layer on the thermochromic core 24. The protective layer may be the upper BoPET layer 30 shown in FIG. 1 that will be opposite the window 23 and have an exterior side 34 as described above. The protective layer may be laminated onto the thermochromic core 24 (e.g. onto the outermost dielectric layer 28 or directly onto a thermochromic film 28) such that the substrate and protective layer sandwich the one or more thermochromic films 28 and optional dielectric layer(s) 26 that form the thermochromic core 24. As noted above, an ultraviolet light absorbing adhesive may be used for laminating the BoPET layer 30 (i.e. the protective layer) on the thermochromic core 24.

With the base layer 22 having been formed, including the thermochromic core 24 sandwiched by the BoPET layers 30 that constitute the substrate and protective layer, the operational flow may continue with a step 230 of laminating one or more sacrificial layers 30a, 30b, 30c, 30d on the BoPET layer 30 serving as the protective layer. Each additional such layer of BoPET may reduce the rate of oxygen diffusion as described above. The total thickness of the solar control system 16 may be limited by the amount of bending required to roll the solar control system 16 during manufacture. For thicker solar control systems 16, it is contemplated that a sheet form process may be used.

In a step 240, the completed solar control system 16 may be applied to the exterior surface of a vehicle window 23 such as an automobile windshield. Prior to such installation, exterior protective layers may have been laminated onto opposed sides of the solar control system 16 to protect the solar control system 16 from oxidation, chipping, ultraviolet light, etc. during storage and transport. Such exterior protective layers may be non-transparent and impermeable to oxygen, for example. Prior to mounting the solar control system 16 to the window 23, the solar control system 16 may be cut to the size of the window 23, after which any such exterior protective layers may be peeled away to expose the solar control system 16.

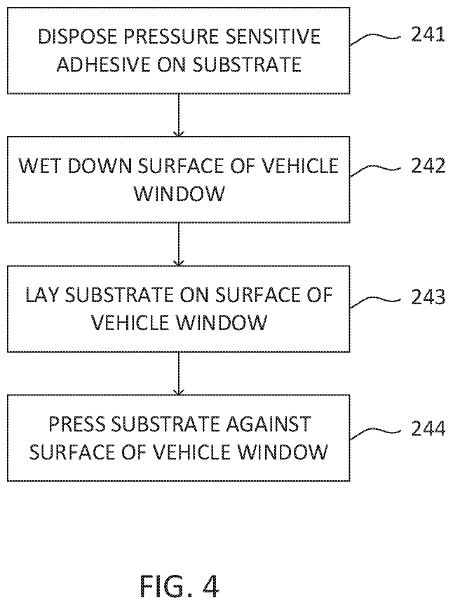

FIG. 4 is an example subprocess of step 240. In a step 241, a pressure sensitive adhesive may be disposed on the exposed side of the base layer 22, e.g. the lower BoPET layer 30 shown in FIG. 1 that serves as the substrate during manufacture. The pressure sensitive adhesive may be based on an elastomer (e.g. acrylic). The pressure sensitive adhesive may continuously cover most, if not all, of the exposed side of the base layer 22. In a step 242, the exterior side of the window 23 may be wetted down with water or other fluid, after which the cut solar control system 16 may be laid over the exterior side of the window 23 in a step 243. The solar control system 16 may then be pressed against the window 23 in a step 244, for example, using a squeegee, during which process any air bubbles may be squeegeed out. The moist adhesive may then be allowed to dry such that the solar control system 16 is mounted to the window 23 and cannot slip.

Referring back to FIG. 2, with the solar control system 16 having been manufactured and applied to the window 23 in accordance with steps 210-240, the solar control system 16 is ready to use. During use, the solar control system 16 may eventually become difficult to see through and/or lose its clean aesthetic appearance due to environmental damage to the outermost sacrificial layer 30a, 30b, 30c, 30d. As such, in a step 250, a user of the solar control system 16 may peel off the outermost sacrificial layer 30a, 30b, 30c, 30d to reveal the next one as described above. To this end, the adhesive used between sacrificial layers 30a-30d and between sacrificial layer 30a and the upper BoPET layer 30 that served as the protective layer during manufacture may have less strength than the adhesive used to adhere the solar control system 16 to the window 23. In this way, when the user pulls on one of the sacrificial layers 30a-30d (e.g. by pulling on a tab as described above), only the sacrificial layer comes off and not the entire solar control system 16. In order to install a new solar control system 16, it is contemplated that the entire solar control system 16 may be taken off with the application of greater pulling force using appropriate tools.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A solar control system for a vehicle window, the solar control system comprising:
a substrate made of biaxially-oriented polyethelene terephthalate;
a thermochromic film formed on the substrate, the thermochromic film including vanadium dioxide nanocrystals; and
a protective layer laminated on the thermochromic film, the protective layer made of biaxially-oriented polyethelene terephthalate.

2. The solar control system of claim 1, further comprising an ultraviolet light absorbing adhesive between the protective layer and the thermochromic film.

3. The solar control system of claim 1, further comprising:
one or more sacrificial layers laminated on the protective layer, the one or more sacrificial layers made of biaxially-oriented polyethelene terephthalate.

4. The solar control system of claim 3, further comprising an ultraviolet light absorbing adhesive between the one or more sacrificial layers and the protective layer.

5. The solar control system of claim 3, wherein each of the one or more sacrificial layers includes a tab for peeling off the sacrificial layer.

6. The solar control system of claim 1, further comprising a pressure sensitive adhesive disposed on an opposite side of the substrate as the thermochromic film.

7. A solar control system for a vehicle window, the solar control system comprising:
a substrate made of biaxially-oriented polyethelene terephthalate;
a thermochromic core disposed on the substrate, the thermochromic core comprising a first dielectric layer formed on the substrate and a first thermochromic film formed on the first dielectric layer, the first thermochromic film including vanadium dioxide nanocrystals; and
a protective layer laminated on the thermochromic core, the protective layer made of biaxially-oriented polyethelene terephthalate.

8. The solar control system of claim 7, further comprising an ultraviolet light absorbing adhesive between the protective layer and the thermochromic core.

9. The solar control system of claim 7, wherein the thermochromic core further comprises a second dielectric layer formed on the first thermochromic film.

10. The solar control system of claim 9, wherein the thermochromic core further comprises a second thermochromic film formed on the second dielectric layer, the second thermochromic film including vanadium dioxide nanocrystals.

11. The solar control system of claim 10, wherein the thermochromic core further comprises a third dielectric layer formed on the second thermochromic film.

12. The solar control system of claim 7 further comprising:
one or more sacrificial layers laminated on the protective layer, the one or more sacrificial layers made of biaxially-oriented polyethelene terephthalate.

13. The solar control system of claim 12, further comprising an ultraviolet light absorbing adhesive between the one or more sacrificial layers and the protective layer.

14. The solar control system of claim 12, wherein each of the one or more sacrificial layers includes a tab for peeling off the sacrificial layer.

15. The solar control system of claim 7, further comprising a pressure sensitive adhesive disposed on an opposite side of the substrate as the thermochromic core.

16. A solar control method for a vehicle, the method comprising:
providing a substrate made of biaxially-oriented polyethelene terephthalate;
forming a first dielectric layer on the substrate;
forming a first thermochromic film on the first dielectric layer, the first thermochromic film including vanadium dioxide nanocrystals; and
laminating a protective layer on a thermochromic core comprising the first dielectric layer and the first thermochromic film, the protective layer made of biaxially-oriented polyethelene terephthalate.

17. The solar control method of claim 16, further comprising rolling the substrate into a roll between said forming the first dielectric layer and said forming the first thermochromic film.

18. The solar control method of claim 16, further comprising disposing a pressure sensitive adhesive on an opposite side of the substrate as the thermochromic core.

19. The solar control method of claim 18, further comprising:
wetting down a surface of a vehicle window;
laying the substrate on the surface of the vehicle window with the side having the pressure sensitive adhesive against the surface of the vehicle window; and
pressing the substrate against the surface of the vehicle window.

20. The solar control method of claim 19, further comprising:
laminating one or more sacrificial layers on the protective layer, the one or more sacrificial layers made of biaxially-oriented polyethelene terephthalate; and
peeling off an outermost sacrificial layer of the one or more sacrificial layers after said pressing.
